(19) United States
(12) Patent Application Publication
(10) Pub. No.: US 2011/0095540 A1
(43) Pub. Date: Apr. 28, 2011

(54) WEATHER RESISTANT PORTABLE GENERATOR WITH A REMOTE ELECTRICAL DISTRIBUTION PANEL

(75) Inventors: Gordon W. Jackson, Clayton, NC (US); Brian K. Sawyer, Clayton, NC (US)

(73) Assignee: GXI Holdings, LLC

(21) Appl. No.: 12/728,232

(22) Filed: Mar. 21, 2010

Related U.S. Application Data
(60) Provisional application No. 61/255,718, filed on Oct. 28, 2009.

(51) Int. Cl. H02K 5/10

(52) U.S. Cl. 290/1 A

(57) ABSTRACT

A weather resistant portable electric generator is disclosed. The weather resistant portable electric generator has a fuel tank which provides fuel to an engine. The engine is connected to an alternator, which is connected to an outlet, the outlet configured to receive an electrical connector. The weather resistant portable electric generator also has a control panel and a moveable cover. The moveable cover can move between a raised and a lowered position. The control panel is located under the moveable cover. When the moveable cover is in the closed position, the moveable cover protects the control panel and outlet from atmospheric conditions.

This application claims priority of U.S. Provisional Application 61/255,718 filed on Oct. 28, 2009 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a portable generator and more specifically to a weather resistant portable generator with an integrated remote electrical distribution panel.

2. Description of Related Art

Electrical generators are commonly used to provide electrical power in situations where conventional wired electrical power grid sources are not available, such as during a power outage, at construction sites, or at remote locations. The generator may use an engine to drive the generator. The generator may have power outlets located on the generator itself.

Typically, portable electric generators are operated outdoors due to the fumes which are a byproduct of the gasoline engine that is running while the portable generator is generating electricity. While outside, the portable electric generator is subject to the weather conditions. If a portable electric generator is in operation while it is raining, significant electrocution hazards may exist. This may be due to improper grounding, exposed wiring or the like.

Another drawback with many conventional portable electric generators is the lack of an integrated remote GFCI (Ground Fault Circuit Interrupt) outlet. A GFCI outlet is designed to provide extra protection for wet areas. A GFCI circuit measures the flow of electricity in both the hot and neutral wires. If the two are not equal, then there is electricity flowing somewhere else out of the circuit and the breaker disconnects the power.

The present invention provides a portable electric generator that is operable in wet conditions. Additional embodiments of the present invention present a means for distributing the electrical power and more specifically GFCI power generated by the portable electric generator via an integrated remote power distribution panel.

### SUMMARY OF THE INVENTION

A weather resistant portable electric generator is disclosed. The weather resistant portable electric generator has a fuel tank which provides fuel to an engine. The engine is connected to an alternator, which is connected to an outlet, the outlet configured to receive an electrical connector. The weather resistant portable electric generator also has a control panel and a moveable cover. The moveable cover can move between a raised and a lowered position. The control panel is located under the moveable cover. When the moveable cover is in the closed position, the moveable cover protects the control panel and outlet from atmospheric conditions.

A weather resistant portable electric generator is disclosed. The weather resistant portable electric generator has a fuel tank which provides fuel to an engine. The engine is connected to an alternator, which is connected to an outlet, the outlet configured to receive an electrical connector. The weather resistant portable electric generator also has a control panel and first and second moveable covers. The first and second moveable covers can move between a raised and a lowered position. The control panel is located under the first moveable cover and the outlet is located under the second moveable cover. When the first and second moveable covers are in the closed position, the first and second moveable covers protect the control panel and outlet from atmospheric conditions.

### BRIEF DESCRIPTION OF THE DRAWINGS

FIG. 1 displays a side perspective view of a weather resistant portable electric generator in accordance with one aspect of the present invention.

FIG. 2 shows a side perspective view of the generator of FIG. 1 with an integrated remote power distribution panel removed.

FIG. 3 displays a front perspective view of the integrated remote power distribution panel in accordance with one aspect of the present invention.

FIG. 4 shows a side perspective view of the integrated remote power distribution panel of FIG. 3.

FIG. 5 shows a front perspective view of the weather resistant portable electric generator with the integrated remote power distribution panel disconnected.

FIG. 6 shows a front perspective view of the weather resistant portable electric generator with the integrated remote power distribution panel connected.

FIG. 7 displays a side perspective view of a weather resistant portable electric generator in accordance with another aspect of the present invention.

FIG. 8 shows a side perspective view of the generator of FIG. 7 with an integrated remote power distribution panel removed.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

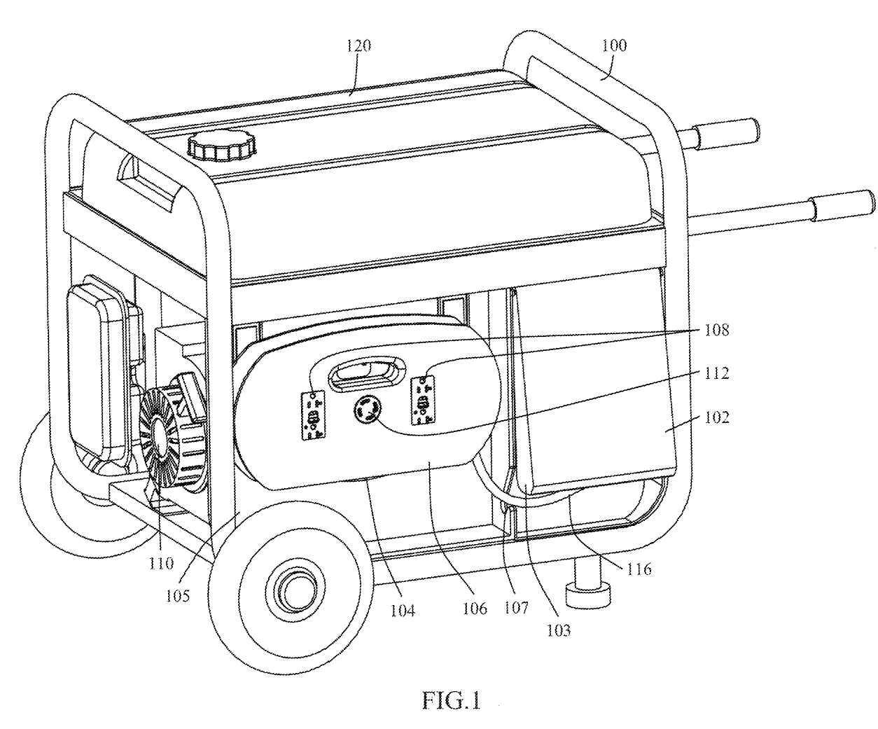

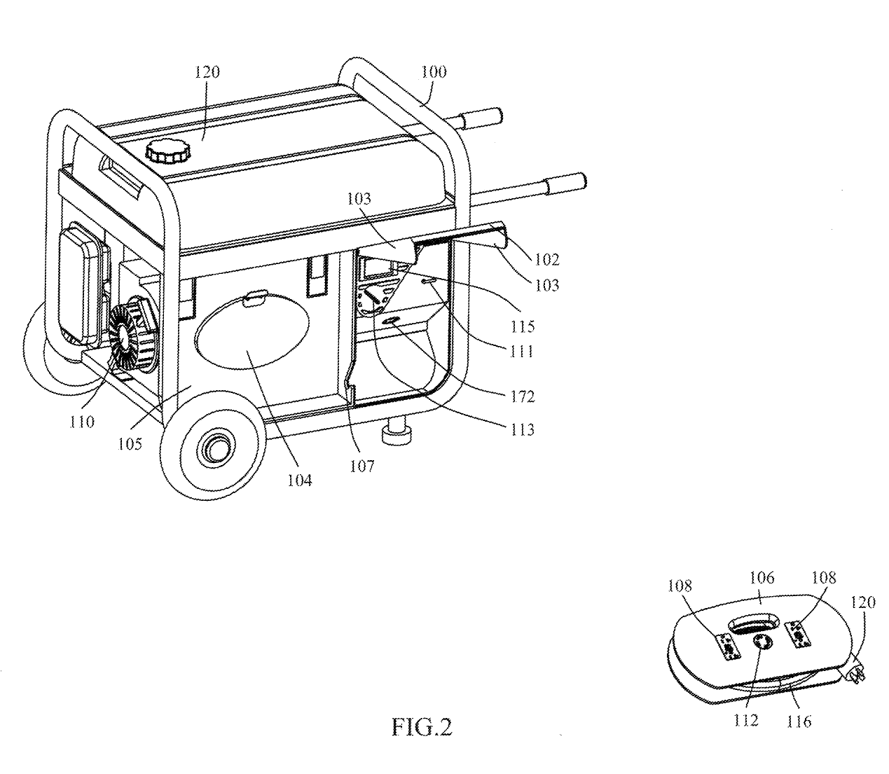

FIGS. 1 and 2 display a side perspective view of a weather resistant portable electric generator (hereinafter referred to as generator 100) [in drawings it looks as if “100” is point to handle not overall figure] in accordance with one aspect of the present invention. Located on the left side of the generator 100 is a starter mechanism 110. In the embodiment of FIG. 1, the starter mechanism 110 is a pull start mechanism. In other embodiments, the starter mechanism 110 may also include an electronic start mechanism depending on the application. On top of the generator 100 is a fuel tank 120 which stores fuel for the engine of the generator (for ease of illustration, the engine of the generator 100 is not shown). In one embodiment of the present invention, the engine may be a gasoline engine. In an alternate embodiment, the engine may run on diesel fuel, natural gas, LP gas or the like. As can be seen in FIG. 1, the fuel tank 120 may be constructed with rounded edges and angled surfaces to facilitate the natural runoff of water, which may come in contact with the generator 100 if the generator 100 is operated in the rain.

As those skilled in the art may appreciate, when the generator 100 is running, fuel is flowing into the engine from the fuel tank 120. The engine in turn is operating an alternator, which in turn, is generating electricity. As part of the operational process, the generator converts mechanical energy into electrical energy. The electrical energy is then provided as power to the operator.

Also shown in FIG. 1 is an integrated remote power distribution panel (hereinafter referred to as power panel 106). Located on the power panel 106 are two 120V GFCI outlets 108 and a 240V outlet 112. The 240V outlet 112 may be a “twist and lock” outlet. When the power panel 106 is connected to the generator 100, and the generator 100 is running, electrical power is provided to the power panel 106. In one embodiment of the present invention, the power panel 106 may hang on a clip 104 (see FIG. 2) located on the side of the generator 100. In the embodiment of FIG. 2, the clip 104 may be positioned on a removable panel 105. The removable panel 105 may provide additional environmental protection for the engine. Should the engine of the generator 100 need servicing, the removable panel 105 may be detached and access to the engine may be granted.

Referring back to FIG. 1, the power panel 106 is connected to the generator 100 via electrical cord 116. In one embodiment, the electrical cord 116 may be routed through a notch 107 and connected to an outlet 172 (See FIG. 2) on the generator 100. In the embodiment of FIG. 1, a cover 102 is shown in a closed position. The cover 102 may swing freely from a lowered position (FIG. 1) to a raised position as shown in FIG. 2.

The length of the cord 116 may vary. In one embodiment the length of cord may be 25 feet. In another embodiment, the length of cable may be 50 feet. When the power panel 106 is positioned on the hook 104 of the generator 100, the cord 116 may be wound around the power panel 106 to allow less clutter. In order to have longer cable lengths, the power panel 106 may need to be larger in circumference to accommodate the winding of the longer cable.

Located under the cover 102 may be a control panel which may consist of various control components as well as outlet 172. In the closed position, the cover 102 may provide protection from adverse weather conditions which may include, but not limited to, rain, sleet, snow and the like. The cover 102 may also have side panels 103 which may also facilitate the protection of the various components under the cover 102.

A cover 102 provisioned with a notch 107 allows the cover 102 to close more completely when the power panel 106 is hanging on the hook 104 and is connected to the generator 100. In this embodiment, the cover 102 may still come in contact with the cord 116, but the cover 102 may close almost to a fully closed position when the cord 116 is routed through the notch 107.

Referring back to FIG. 2, the cover 102 may be raised to the open position to allow the operator access to the control panel and the various control components. Some exemplary control components that may be positioned under the cover 102 may include but are not limited to a display 115, a control switch 113 (i.e. an OFF/ON switch), a breaker 111, an outlet 172, and the like. In one embodiment the display 115 may be a simple alpha numeric display. In another embodiment, the display 115 may be an LCD display. An LCD display may be able to provide the operator additional information such as but not limited to graphical representations of the amount of fuel remaining, hours the generator 100 had been running, amount of power generated, oil replacement schedule, and the like.

Similar to the surfaces of the fuel tank 120, the surfaces that the various components may be mounted upon may also be angled in order to facilitate the flow of water off the generator 100. For example, the surface that the outlet 172 is positioned on is angled away from the cover 102. The surface is angled in this manner so any water that comes in contact above the outlet 172, would drip away from the edge of the surface and not drip on the outlet 172. Directing water away from the electrical components may provide additional safeguards for the operator. Water may gather on these surfaces should the cover 102 be opened while the generator was operating in inclement conditions.

Certain other weather resistant characteristics may be applied to the generator 100. For example, in one embodiment of the present invention, the cover 102 may be clear. A clear cover would allow the operator to view the display 115 or view the condition of the breaker 111 when the cover 102 is in the closed position. Keeping the cover 102 in the closed position during inclement weather conditions may provide protection to the components. Other weather resistant characteristics of the present invention may include a display 115 that is sealed such that it may be impervious to water. The same weather resistant concept may be applied to the control switch 113. The control switch 113 may be moved from one position to another within a sealed environment. Additional weather resistant concepts are described in greater detail in subsequent sections.

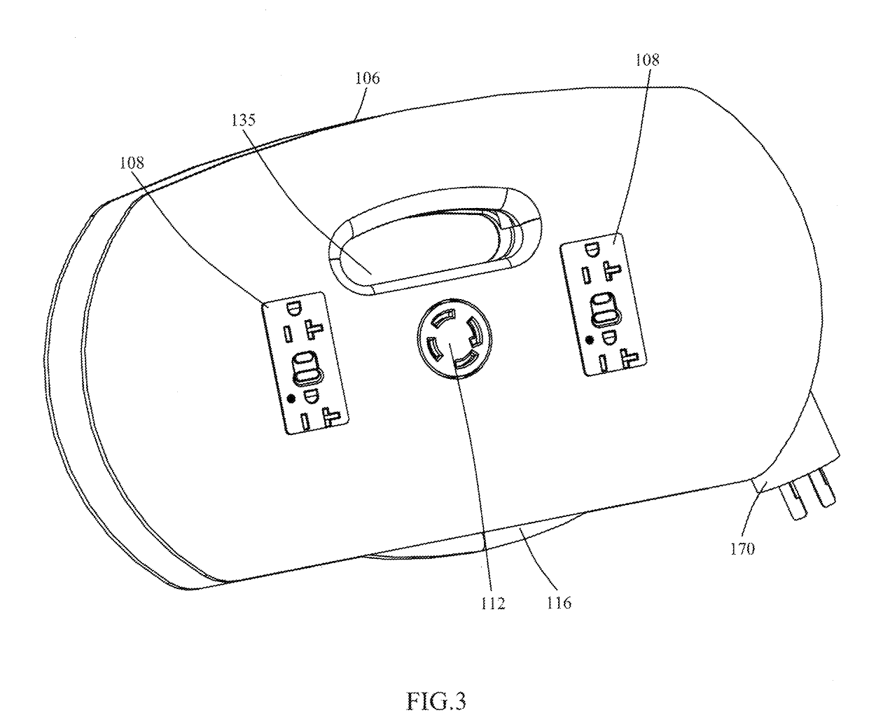

FIG. 3 displays a front view of the power panel 106. The 120V GFCI outlets 108 are shown on either side of the 240V twist and lock receptacle 112. The cord 116 is shown wrapped around the power panel 106. As mentioned previously, at one end of the cord 116 is a connector 170. In one embodiment, the connector 170 may be a 240V twist and lock connector. On the connector 170 may also be a gasket (not shown for ease of illustration) to provide a seal when the connector is coupled to the power outlet 172 (See FIG. 2) on the generator 100. At the other end of the cord 116, the electrical wiring is integrated into the power panel 106. Integrating the wiring directly into the power panel 106 allows the operator to make only one connection when attaching the power panel to the generator 100.

To facilitate the hanging of the power panel 106 on the hook 104, a handle opening 135 or other type of opening may be implemented. The handle opening 135 may also provide an easy way for the operator to remove the power panel 102 from the hook 104 and carry it to a remote location. Locating the power panel 102 away from the generator 100 may allow the operator to operate the generator 100 outside in the weather elements while providing GFCI power into an interior of a home. The use of GFCI circuitry allows the manufacturer to provide an additional level of operator protection while providing reliable remote power.

As those skilled in the art may appreciate, A GFCI outlet is a device that adds a greater level of safety by reducing the risk of electric shock. Most building codes may require that a GFCI outlet be used in wet locations such as bathrooms, kitchens, laundry rooms and outdoors. A GFCI outlet monitors for a current imbalance between the hot and neutral wires and breaks the circuit if that condition occurs. A circuit breaker usually may trip if a short is experienced, but it may not act fast enough to protect the operator from harm. A GFCI outlet is more sensitive and acts faster than a circuit breaker or fuse and is thus an important safety feature.

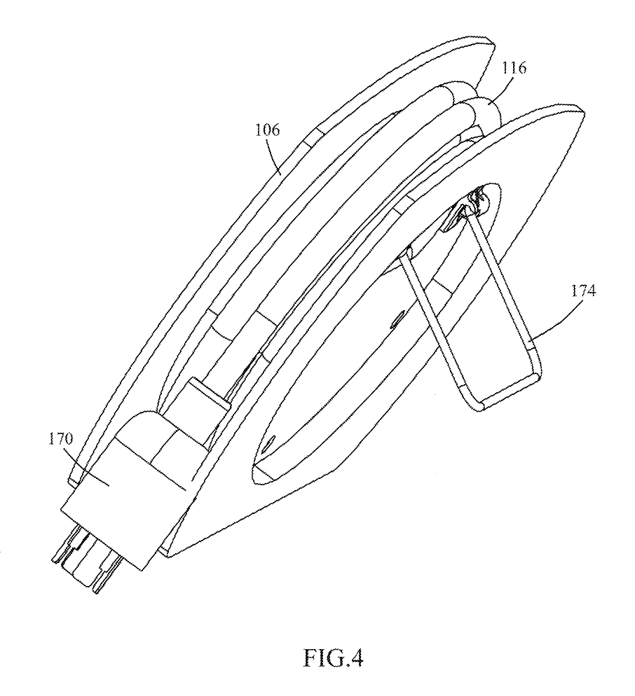

FIG. 4 displays a side view of the power panel 106. A swivel stand 174 is shown extending away from the bottom of the power panel 106. The swivel stand 174 attaches to the power panel 106 near the handle opening 135 (see FIG. 3). Extending the swivel stand 174 outward allows the operator to position the power panel 106 on the ground or other surface without laying it completely flat.

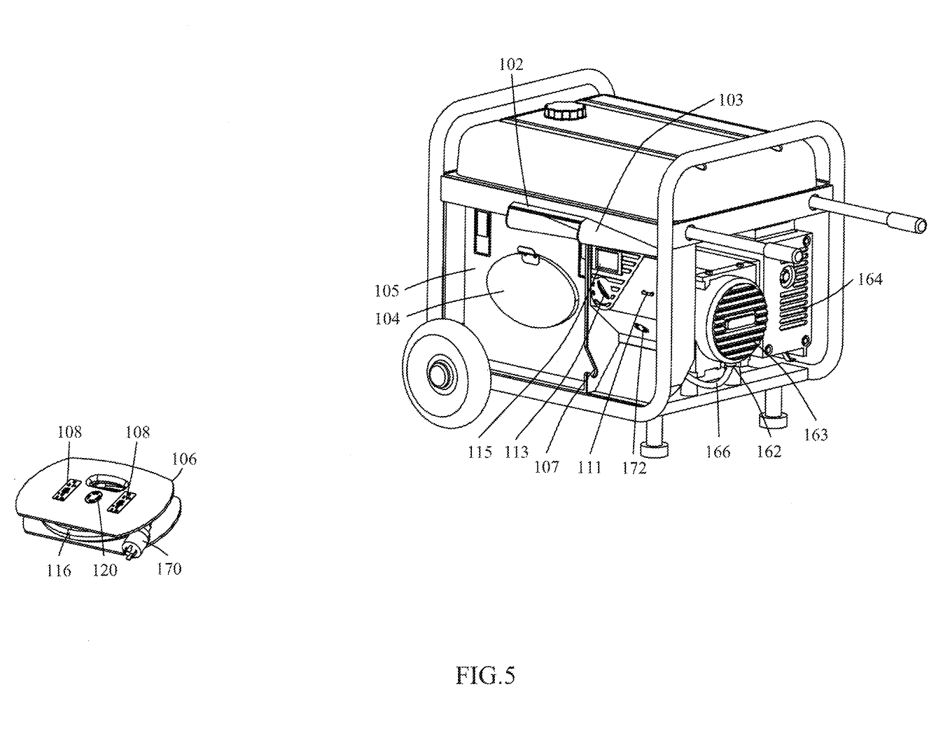

FIG. 5 displays another side perspective view of the generator 100. From this view, the alternator 162 and the exhaust panel 164 may be seen. On the end of the alternator are louvers 163. In one embodiment, the louvers 163 may be angled to allow air to flow through the alternator but provide some protection from the elements. Louvers may also be added to the cover of the exhaust panel 164 as well. Extending away from the alternator is wiring 166. As can be seen in FIG. 5, the wiring 166 may be positioned such that any water that is encountered would drip off the wiring without entering into the engine compartment. In this embodiment, the wiring 166 is angled downward as it exits the alternator 162 and then upwards as it is directed to the back of the control panel and is connected to the outlet 172. As water drips on the wiring 166, it will gather at the apex of the wiring 166 and eventually drip off rather than be directed into the generator 100.

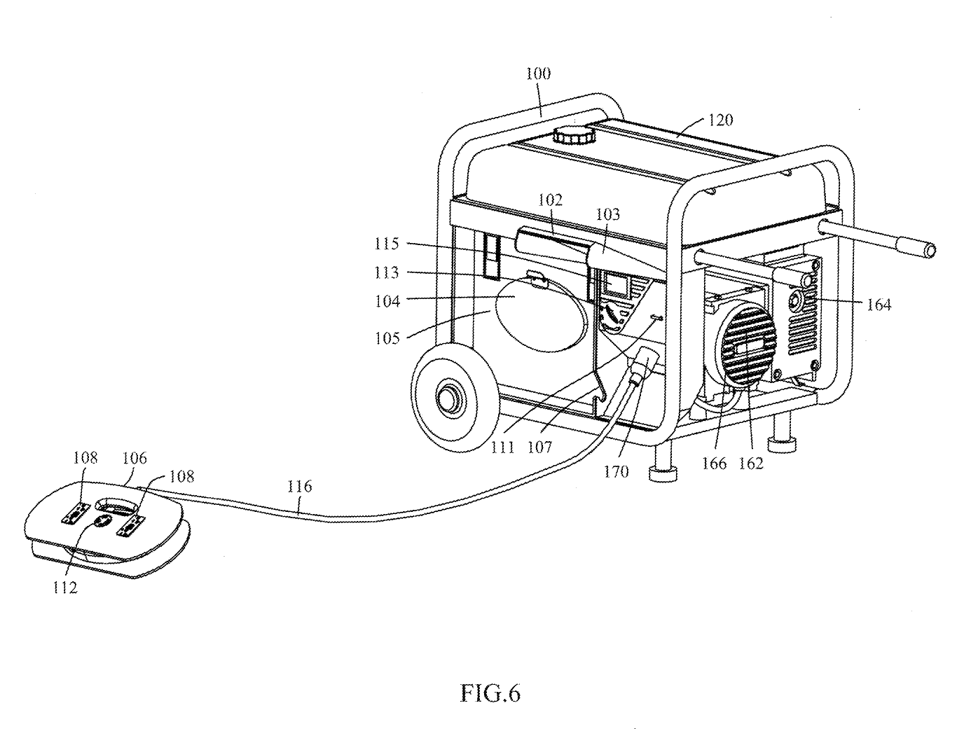

FIG. 6 shows the cover 102 in an open position. The power panel 106 is shown attached to the generator 100 through the connector 170. When the cover 102 is lowered into the closed position, the sides 103 of the cover 102 provide added weather resistant protection even when the power panel 106 is connected.

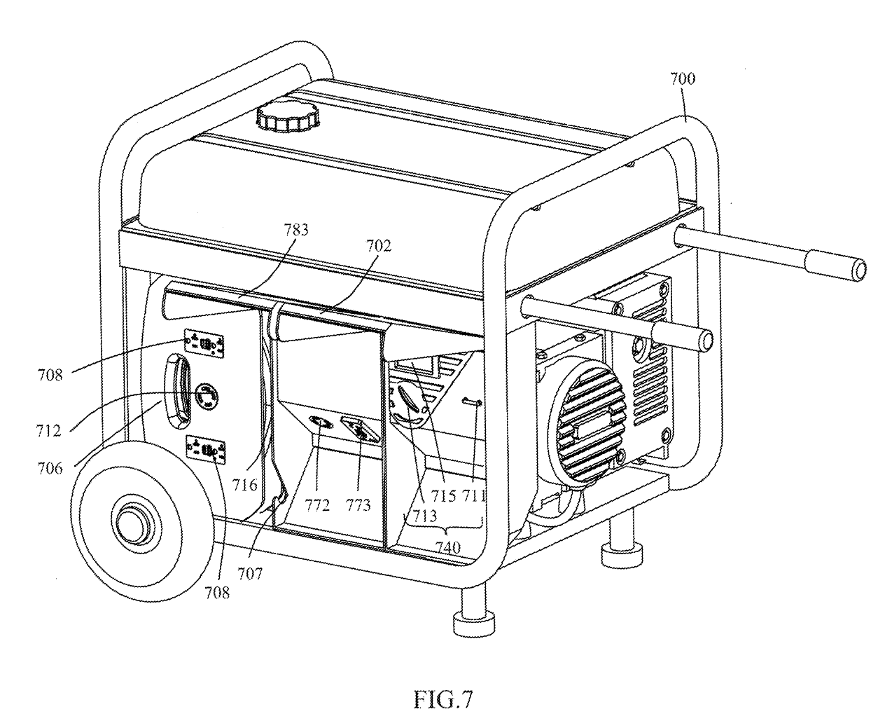

FIG. 7 displays a weather resistant generator 700 in accordance with another embodiment of the present invention. The generator 700 is similar to the generator 100 except that there are separate covers 702 and 783 covering control components 740 and outlets 772 and 773 respectively. Outlet 772 may be a 220 VAC outlet and outlet 773 may be a 120 VAC. As mentioned previously, some exemplary control components 740 that may be positioned under the cover 702 may include but are not limited to a display 715, a control switch 713, a breaker 711, and the like. As displayed in FIG. 7, the control switch 713 and display 715 and breaker 711 may be under cover 702 while outlets 772 and 773 may be positioned under cover 783.

In one embodiment the display 715 may be a simple alpha numeric display. In another embodiment, the display 715 may be an LCD display. An LCD display may be able to provide the operator additional information such as, but not limited to, graphical representations of the amount of fuel remaining, hours the generator 700 had been running, amount of power generated, oil replacement schedule, and the like.

Also shown in FIG. 7 is a power panel 706. Located on the power panel 706 are two 120V GFCI outlets 708 and a 240V outlet 712. The 240V outlet 712 may be a “twist and lock” outlet. When the power panel 706 is connected to the generator 700, and the generator 700 is running, electrical power is provided to the power panel 706. In one embodiment of the present invention, the power panel 106 may hang on a clip located on the side of the generator 100. The clip may be positioned on a removable panel which may provide additional environmental protection for the engine. Should the engine of the generator 700 need servicing, the removable panel may be detached and access to the engine may be granted.

The power panel 706 is connected to the generator 700 via electrical cord 716. In one embodiment, the electrical cord 716 may be routed through a notch 707 and connected to an outlet 772 on the generator 700. The length of the cord 716 may vary. In one embodiment, the length of cord may be 25 feet. In another embodiment, the length of cord may be 50 feet. When the power panel 706 is positioned on the generator 700, the cord 716 may be wound around the power panel 706 to allow less clutter. In order to have longer cable lengths, the power panel 706 may need to be larger in circumference to accommodate the winding of the longer cable.

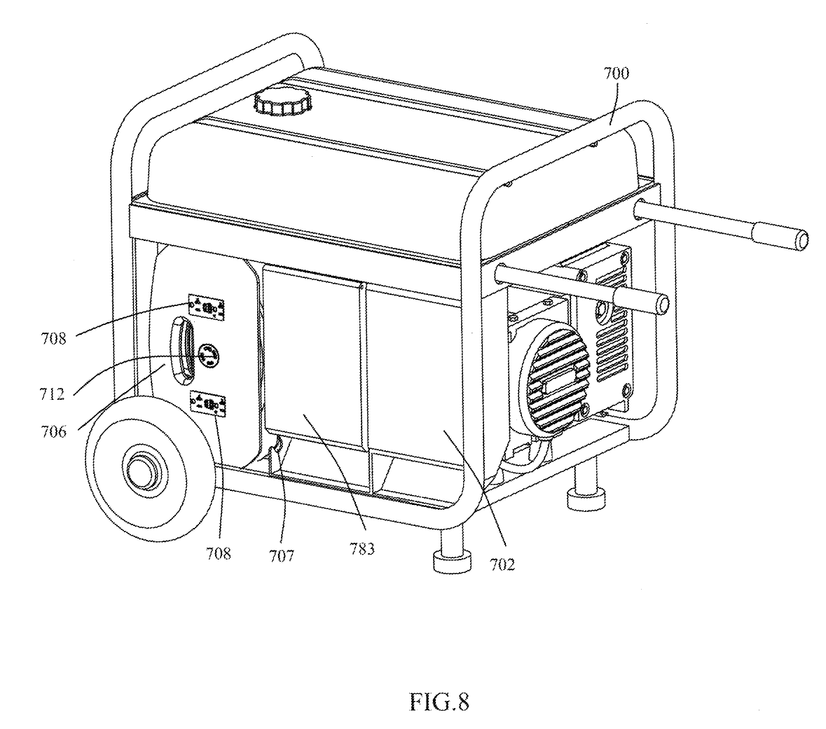

FIG. 8 displays the generator 700 with the covers 702 and 783 in a lowered position. As mentioned previously, keeping the covers 702 and 783 in the lowered position may afford some protection of the control panel to atmospheric conditions. In one embodiment of the present invention, the covers 702 and 783 may be clear. A clear cover would allow the operator to view the display 715 or view the condition of the breaker 711 when the cover 702 is in the closed position. Other weather resistant characteristics of the present invention may include a display 715 that is sealed such that it may be impervious to water. The same weather resistant concept may be applied to the control switch 713 (under the cover 783). The control switch 713 may be moved from one position to another within a sealed environment.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A weather resistant portable electric generator comprising:
a fuel tank providing fuel and attached to
an engine, the engine coupled to
an alternator, the alternator electrically coupled to
an outlet, the outlet configured to receive an electrical connector,
a control panel,
a moveable cover, the moveable cover moveable between an raised and lowered position, the outlet and control panel located under the moveable cover, wherein when the moveable cover is in the lowered position, the moveable cover protects the outlet and control panel from atmospheric conditions.

2. The weather resistant portable electric generator of claim 1 further comprising a remote power distribution panel, the remote distribution panel electrically coupled to the outlet by a cable.

3. The weather resistant portable electric generator of claim 2 wherein the cable is integrated into the remote power distribution panel.

4. The weather resistant portable electric generator of claim 2 wherein the power distribution panel is a GFCI power distribution panel.

5. The weather resistant portable electric generator of claim 1 wherein the moveable cover is clear.

6. The weather resistant portable electric generator of claim 1 wherein the outlet is configured to receive a 220V twist and lock connector.

7. The weather resistant portable electric generator of claim 1 wherein the atmospheric conditions may be rain.

8. The weather resistant portable electric generator of claim 1 wherein the moveable cover is self closing.

9. The weather resistant portable electric generator of claim 1 wherein the moveable cover further comprises side walls.

10. The weather resistant portable electric generator of claim 2 wherein the remote power distribution panel further comprises a swivel stand.

11. The weather resistant portable electric generator of claim 1 wherein the atmospheric conditions may be caused by a sprinkler.

12. A weather resistant portable electric generator comprising:
a fuel tank providing fuel and attached to
an engine, the engine coupled to
an alternator, the alternator electrically coupled to
an outlet, the outlet configured to receive an electrical connector,
a control panel,
a first and a second moveable cover, the first and second moveable cover moveable between an raised and lowered position, the outlet located under the first moveable cover and the control panel located under the second moveable cover, wherein when the first and second moveable covers are in the lowered position, the first and second moveable covers protect the outlet and control panel from atmospheric conditions.

13. The weather resistant portable electric generator of claim 12 further comprising a remote power distribution panel, the remote distribution panel electrically coupled to the outlet by a cable.

14. The weather resistant portable electric generator of claim 13 wherein the cable is integrated into the remote power distribution panel.

15. The weather resistant portable electric generator of claim 13 wherein the power distribution panel is a GFCI power distribution panel.

16. The weather resistant portable electric generator of claim 12 wherein the first and second moveable covers are clear.

17. The weather resistant portable electric generator of claim 12 wherein the outlet is configured to receive a 220V twist and lock connector.

18. The weather resistant portable electric generator of claim 12 wherein the atmospheric conditions may be rain.

19. The weather resistant portable electric generator of claim 12 wherein the atmospheric conditions may be sleet.

20. The weather resistant portable electric generator of claim 12 wherein the moveable cover further comprises side walls.

21. The weather resistant portable electric generator of claim 12 wherein the moveable cover further comprises side walls.

22. The weather resistant portable electric generator of claim 13 wherein the remote power distribution panel further comprises a swivel stand.
